(19) United States
(12) Patent Application Publication
(10) Pub. No.: US 2008/0062434 A1
(43) Pub. Date: Mar. 13, 2008

(54) Arrangement and Method for Scanning a Number of Objects

(75) Inventor: Rolf Diefenbacher, Eglisau (CH)

Correspondence Address: SHOEMAKER AND MATTARE, LTD, 10 POST OFFICE ROAD - SUITE 110, SILVER SPRING, MD, 20910, US

(73) Assignee: DIENER AG PRECISION MACHINING, Embrach (CH)

(21) Appl. No.: 11/577,479

(22) PCT Filed: Oct. 19, 2005
(86) PCT No.: PCT/EP05/55351

§ 371 Date: Sep. 19, 2007

(30) Foreign Application Priority Data
Oct. 19, 2004 (EP) 04024827.0

(51) Int. Cl. G01B 11/24

(52) U.S. Cl. 356/607; 356/606

(57) ABSTRACT

The invention relates to an arrangement (e.g. based on triangulation) for scanning objects (1.1, 1.2) with a light beam, during which this light beam is moved relative to the surface of the object (1.1, 1.2). The arrangement comprises at least two object holders and means for generating at least one light beam per object (1.1, 1.2) and comprises light receivers assigned to each light beam. The inventive arrangement enables at least two objects (1.1, 1.2) to be scanned at the same time To this end, at least two measuring heads are used, which illuminate the objects by using a common system of mirrors and which scan the surface of the objects.

The present invention relates to a scanning arrangement and a method for the simultaneous scanning of a number of objects according to the precharacterizing clauses of the independent claims.

It is known to scan three-dimensional objects with light in order to produce a digital representation of the object. Arrangements suitable for this purpose are known for example from DE 33 15 576, DE 42 08 455 or EP 671 679.

In the case of scanning arrangements according to the aforementioned documents, a light beam is directed over the surface of an object to be measured. The object may in this case be stationary, rotated or pivoted. The light beam may be deflected by movably arranged light sources or by pivotable mirrors or combinations thereof. The data recording is usually performed with locally resolving CCD arrays, with which a triangulation is possible.

Common to all these devices is that only one object can be scanned at a time. The scanning is therefore relatively slow. A problem addressed by the present invention is to avoid the disadvantages of the known art, that is in particular to provide an arrangement and a method by which faster scanning is possible with the same scanning accuracy. At the same time, a problem that is particularly addressed by the invention is for the arrangement to be compact and not differ significantly in its dimensions from a known measuring arrangement.

This problem is solved by a scanning arrangement and a method according to the characterizing clauses of the independent claims.

The scanning arrangement for scanning objects with a focused light beam has at least two object holders. As in conventional arrangements, the light beam is moved in relation to the surface of the object. It is also irrelevant whether the light beam is focused by the light source itself, as may be the case with a laser, or whether a focusing arrangement focuses the light beam. The object holders are designed for receiving at least one object each.

Furthermore, means for producing at least one light beam per object are provided. To produce a number of light beams, a number of light sources may be used. A beam splitter, with which a beam is split into a predetermined number of light beams, may also be used.

Each light beam is assigned a light receiver. Light-sensitive detectors, such as for example photodiodes or CCD units, may serve as light receivers. Particularly suitable are locally resolving CCD arrays, with which the scanning is performed by the triangulation principle. A scanning arrangement and a method that are particularly suitable for adaptation to the present invention are described in the application EP 04 00 5732. The disclosure from that application is hereby incorporated into this description by cross-reference.

A particular advantage of the present invention is that a number of objects can be scanned simultaneously in the same arrangement. Simultaneously means that, at least for a certain time, at least one light beam impinges on at least two objects at the same time. As a result, the entire scanning time can be reduced when a number of objects are to be recorded. This is the case for example if impressions of both ears or associated precision-engineered parts are to be recorded. Furthermore, it is possible to arrange the elements of the scanning arrangement in such a way that the arrangement is not much larger than a conventional arrangement. Seen overall, such a scanning arrangement for each object to be scanned is more favorable, because a number of elements of the arrangement can be used simultaneously when scanning both objects.

In a preferred embodiment of the invention, two holders for objects are provided. Consequently, two objects can be scanned at the same time. The two objects may be, for example, the two impressions of the ears of a hearing aid user.

At least one of the holders is advantageously assigned a magazine. The magazine comprises receiving locations for receiving and presenting a predetermined number of objects. The objects are inserted from the magazine into the assigned holder and retrieved again by the magazine after the scanning in an automated manner. For this purpose, robot arms are advantageously used, but other contrivances are likewise conceivable. If only few objects are to be presented in the magazine, manual changing of the objects is also conceivable.

The receiving locations of the magazine are advantageously numbered. The objects are then transferred to the holder in a predetermined sequence.

Alternatively or in addition, the receiving locations of the magazine may be coded for the unique reception of objects. Coding may be provided for example by the shape of the receiving openings. All contrivances that make unique reception of objects in the receiving locations of the magazine possible are regarded as coding. Unique means that the position and/or the alignment of the object in the receiving location with respect to the magazine can be uniquely assigned.

In the case of a particularly suitable form of coding, the object is placed in the magazine on a carrier, which is brought to the object holder together with the object. The carrier may be provided with a machine-readable coding, for example a barcode, an electronic chip or an RF tag. Furthermore, the carrier may be designed such that the position and/or alignment of the object in relation to it is unique. As a result, the position and/or alignment of the object with respect to the carrier is unequivocally known and can also be reproduced when the object is placed on the holder from the magazine.

In a preferred embodiment, the holders are designed to be suitable for receiving models of sets of teeth or models of single teeth. In this embodiment, the receiving locations of the magazine are made particularly advantageously for the ordered or coded reception of models of single teeth. The magazine then advantageously comprises 8, 16 or 32 receiving locations, so that the teeth of half a jaw, an entire jaw or both jaws can be received. If it is assumed that no wisdom teeth have to be scanned, a magazine with 7, 14 or 28 receiving locations may also be suitable.

The scanning arrangement advantageously comprises a mirror arrangement, by means of which the light from a least two light sources is directed onto the corresponding object. The light is then moved simultaneously over a number of objects. As a result, space can be saved in the arrangement and the costs can be reduced. Another advantage of a common arrangement is that the mirror arrangement requires only one drive, whereby the costs can be lowered further. Furthermore, in particular in the case of objects that are related to one another, the errors caused by tolerances can be reduced.

Furthermore, it is advantageous if at least two holders are movably arranged. In order to save costs, the two holders may be driven by the same drive, it being possible for the power transmission to take place for example by means of couplings or belts.

The method for the three-dimensional scanning of objects with a focused light beam is characterized in that a number of objects are scanned at the same time with the same scanning arrangement. At least one light beam is used for each object. The method is performed particularly advantageously with an arrangement as described above.

In a preferred embodiment, two objects are scanned at the same time. These may be, for example, the impressions of the ears of a patient.

With preference, models of sets of teeth or single teeth are scanned. Other application areas are likewise conceivable. The method is also suitable for the scanning of impressions of ears, mechanical precision parts or other objects.

Digital representations of the simultaneously scanned objects can advantageously be combined into one image. In the case of mechanical precision parts, for example gear wheels, the interaction between two parts can in this way be analytically recorded.

In a further preferred embodiment, an object and a detail of the same are simultaneously scanned. With particular preference, these are a model of a set of teeth and one or more models of single teeth. The digital representations of the object and of the detail are advantageously combined to form an at least partially overlapping representation. If the object is a model of a set of teeth and the detail is one or more models of single teeth of the same set of teeth, the representations of the tooth or the teeth can be incorporated in the representation of the set of teeth. In the case of models of sets of teeth, there is generally the problem that the spaces between the teeth cannot be recorded, or only very poorly. This problem can be reduced with an arrangement according to the invention, because the scanning of individual teeth also allows the spaces between the teeth to be recorded. For example, models of sets of teeth and individual models of single teeth from the set of teeth can be recorded at the same time and combined into one image. It is also possible with other objects to increase the accuracy by separately scanning a detail of the object. A particular advantage of the present method is that, by virtue of the simultaneous scanning of the object and the detail, the measuring time is not increased.

With the use for example of one drive for a number of elements of the arrangement, it is advantageous that errors caused by tolerances are reduced.

With particular advantage, the alignment of the object and of the detail with respect to each other is referenced. This is made easier in particular if the detail is presented in a magazine on which the positioning is coded. As a result, the alignment of the detail is already known and only has to be brought into conjunction with the object itself. The mutual referencing of the detail and the object with respect to each other makes it easier for the representations to be combined. The computing power required for presenting the image can be reduced, since an initial position of the images with respect to each other is already provided for the combining operation. From this initial position, it is just necessary to allow for minor deviations corresponding to mechanical tolerances.

The invention is explained below on the basis of exemplary embodiments and figures, in which:

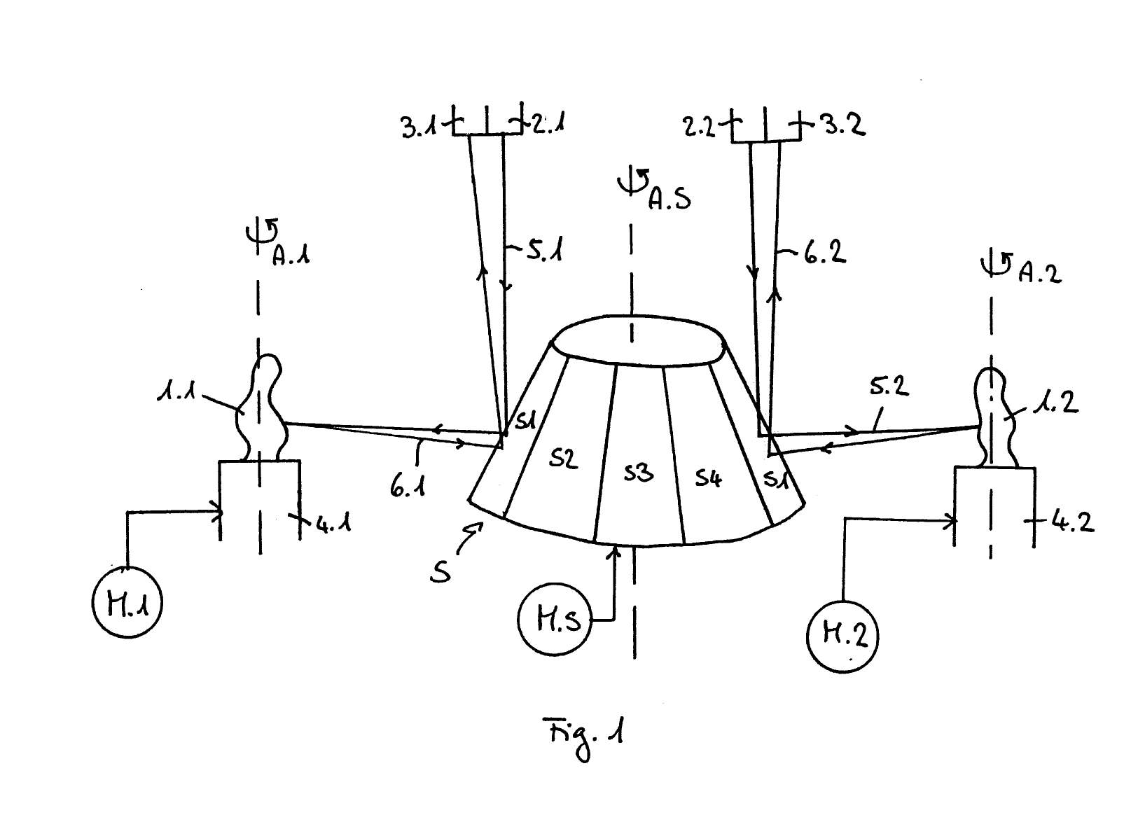

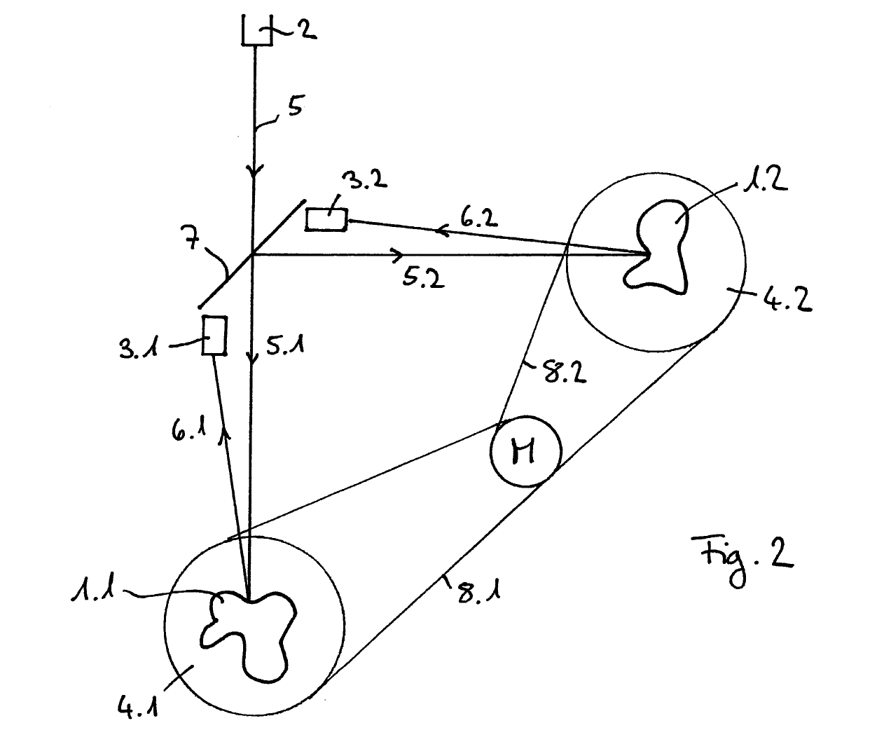

FIG. 1 shows a schematic representation of a preferred embodiment of the arrangement according to the invention,

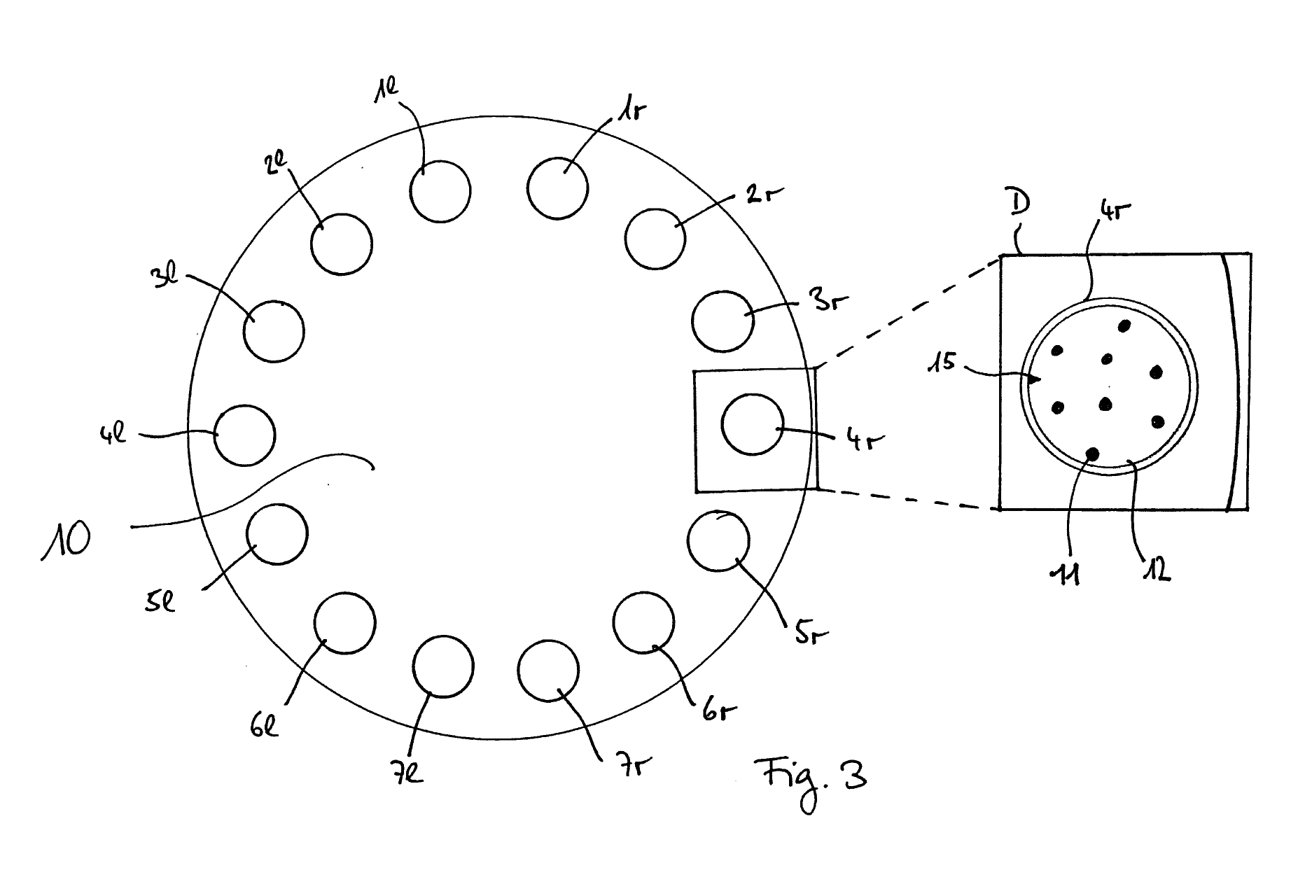

FIG. 2 shows a schematic representation of an alternative embodiment of the arrangement according to the invention,

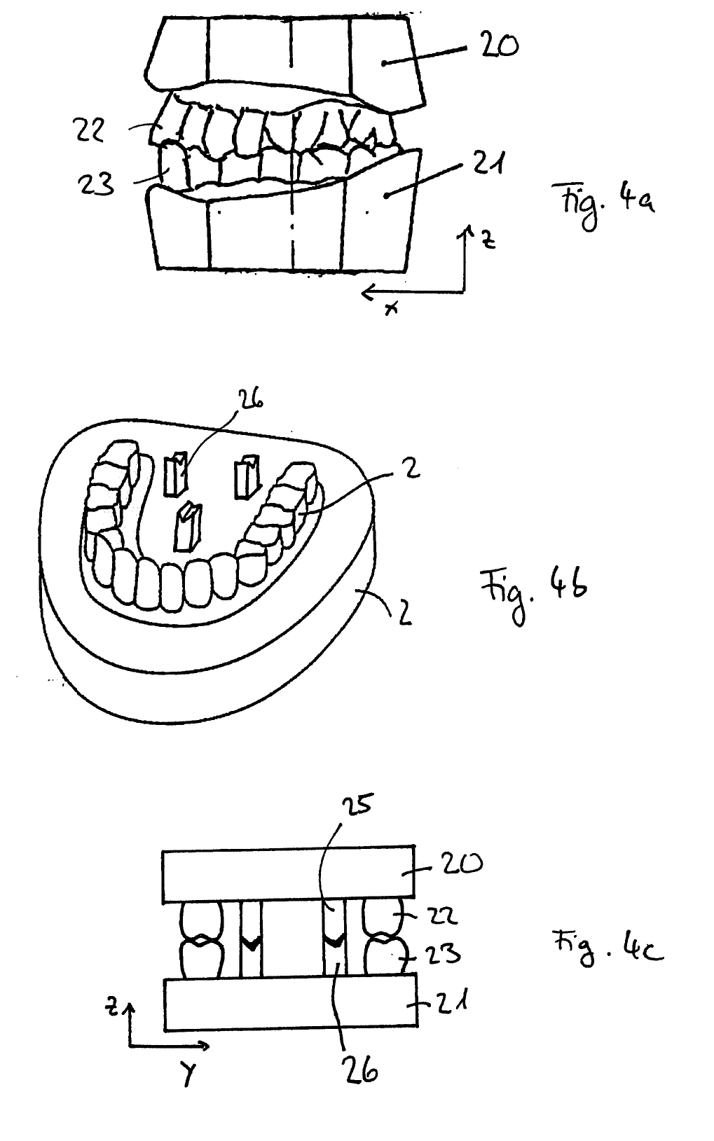

FIG. 3 shows a representation of a magazine for the arrangement according to the invention,

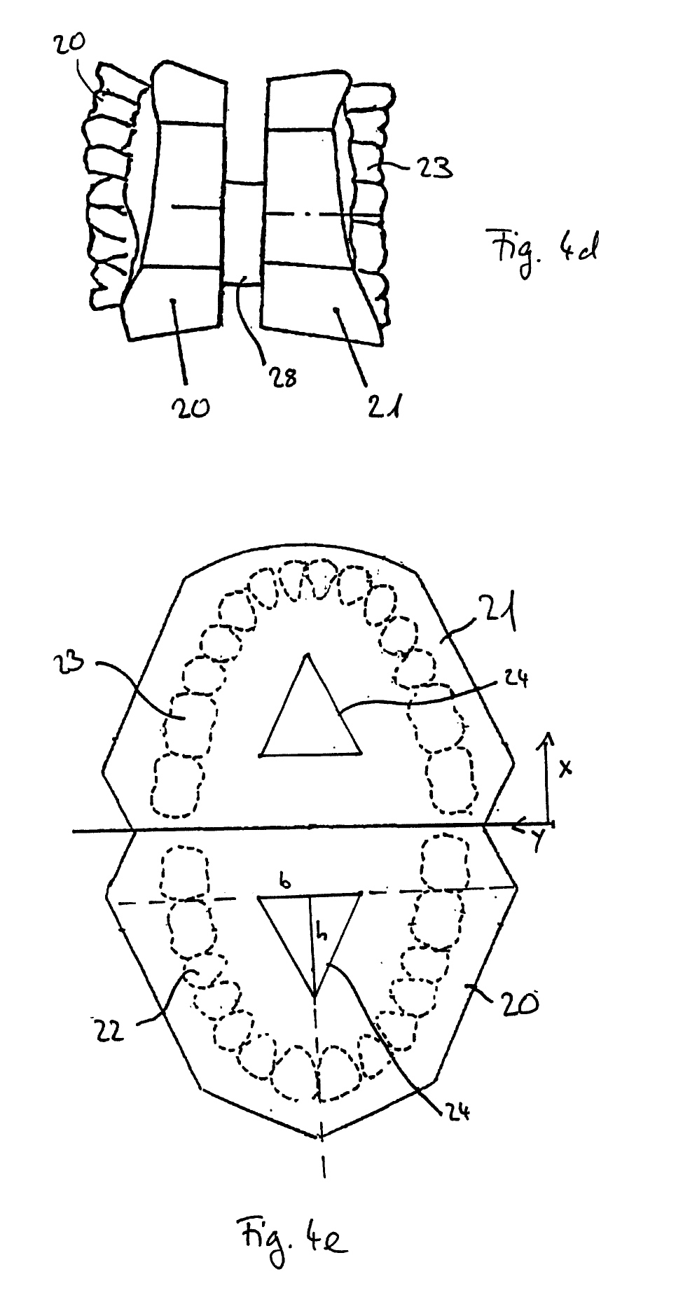

FIGS. 4a to 4e show representations of models of sets of teeth in various views,

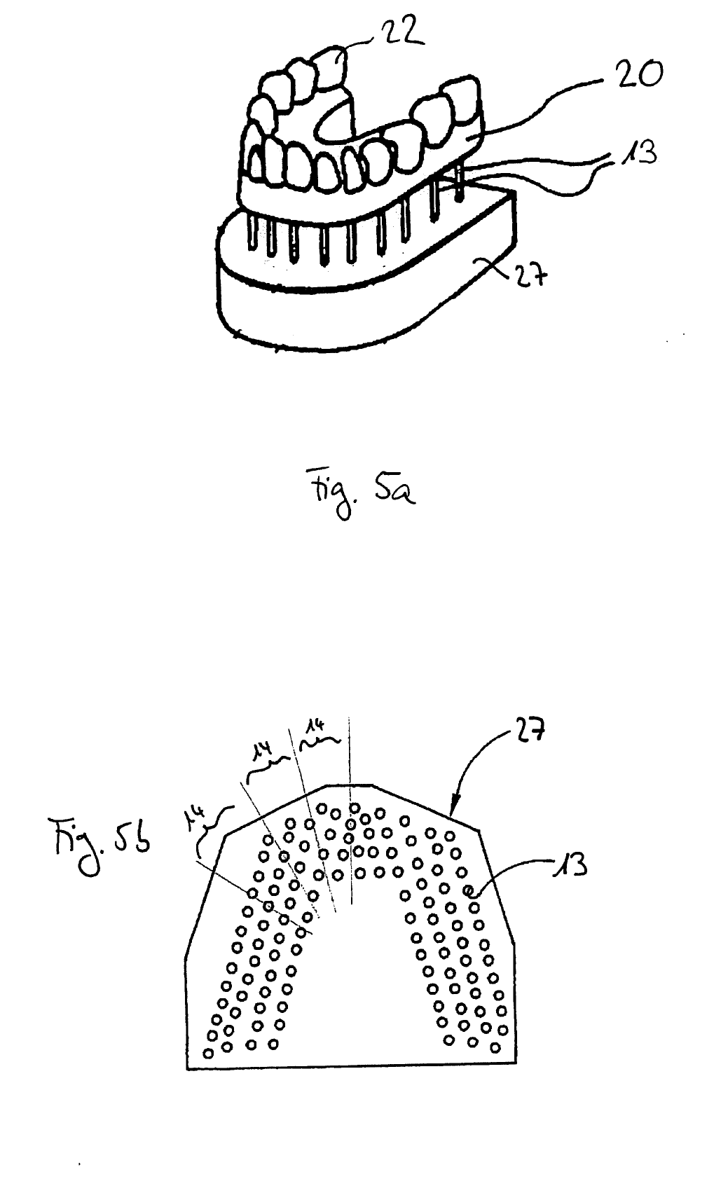

FIGS. 5a and 5b show explanations of the standard coding of the models of single teeth, and

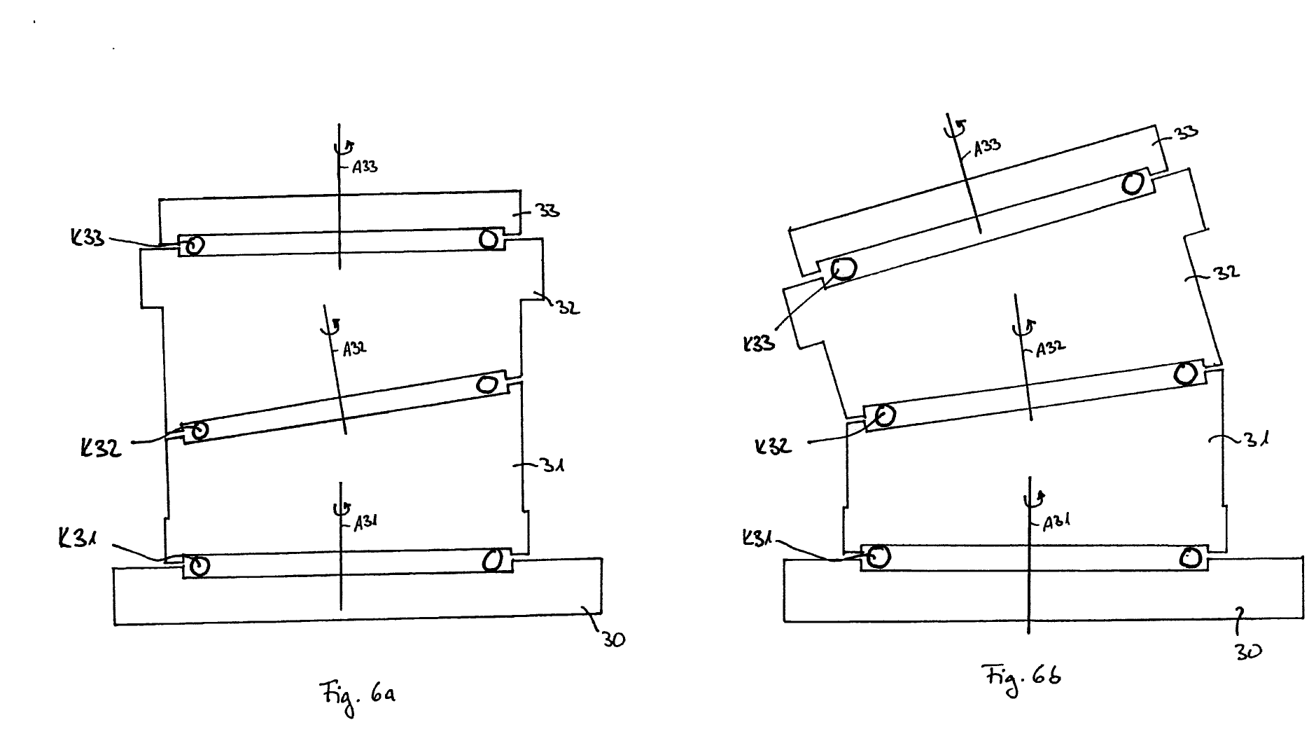

FIGS. 6a and 6b show a suitable object holder in two positions.

The preferred embodiment of the scanning arrangement according to FIG. 1 is suitable for the scanning of two objects 1.1 and 1.2. The objects 1.1 and 1.2 are each fastened on a holder 4.1 and 4.2. The holders 4.1 and 4.2 can be rotated about the axes A.1 and A.2. The holders 4.1 and 4.2 are driven by the two motors M.1 and M.2. Consequently, each of the two holders 4.1 and 4.2 can be moved independently of the other.

Serving as light sources are the laser light transmitters 2.1 and 2.2. Each light source is assigned a detector 3.1 and 3.2. The detectors 3.1 and 3.2 are locally resolving detector arrays, which are suitable for triangulation. This determines the distance of the measuring points from the detector. In this example, laser detector units of the Fairchild Semiconductors company are used.

The light beams 5.1 and 5.2 are directed from the laser transmitters 2.1 and 2.2 onto the objects 1.1 and 1.2 by means of a mirror arrangement S. In the mirror arrangement S, eight mirrors S1 to S4 are arranged in a conical form. Every two mirrors S1, as a pair, are at the same inclination with respect to the axis A.S and are arranged lying opposite each other on the cone. The same applies to every two mirrors S2, S3 and S4.

The laser light 5.1 and 5.2 from the transmitters 2.1 and 2.2 is respectively directed at two opposing mirrors S1 to S4. Since opposing mirrors are at the same inclination, the light beams 51 and 5.2 are directed onto the object 1.1 and 1.2 at the same angle. This is possible because the two objects 1.1 and 1.2 are arranged approximately in the same plane, which is perpendicular to the axis A.S. The overall scanning arrangement is therefore symmetrical.

The light beams 5.1 and 5.2 are reflected at the objects 1.1 and 1.2. The reflected light beams 6.1 and 6.2 are directed again by means of the mirror arrangement into the two detectors 3.1 and 3.2. The data received are passed on to a computing arrangement (not represented), which is part of the scanning arrangement. The data are evaluated in the computing arrangement and can be transmitted to a commercially available PC by means of a standard interface, for example a USB interface.

An alternative embodiment can be seen from FIG. 2. The arrangement is represented in plan view. The light of the laser light transmitter 2 is split in a beam splitter 7. Consequently, two light beams 5.1 and 5.2 are produced for scanning the objects 1.1 and 1.2.

By analogy with the example according to FIG. 1, the holders 4.1 and 4.2 can each be rotated about a vertical axis (perpendicular to the plane of the figure). Furthermore, the holders can be adjusted in height along these axes. The height adjustment is performed by means of a thread. Therefore, a separate motor is not required for the height adjustment. The holders 4.1 and 4.2 are driven by means of the common motor M; the power transmission takes place by means of the belts 8.1 and 8.2.

The reflected light beams 6.1 and 6.2 are received in the two detectors 3.1 and 3.2. The detectors may also be arranged in such a way that the reflected light 6.1 and 6.2 is passed through the beam splitter. However, this is less advantageous, because interference effects may then occur.

In all the exemplary embodiments, the collected data are passed on to a computing arrangement (not represented). This computing arrangement may either be a permanent part of the scanning arrangement or be connected to the arrangement as and when required.

An arrangement as shown in FIG. 1 or 2 can be used particularly advantageously for the scanning of models of sets of teeth. With models of sets of teeth, there is generally the problem that the spaces between the teeth cannot be recorded, or only very poorly. With an arrangement according to the present invention, models of sets of teeth and individual models of single teeth from the set of teeth can be recorded at the same time and combined into one image.

For the scanning of individual models of single teeth, a magazine 10 as represented in FIG. 3 is advantageously used. A magazine 10 has 14 receiving locations 1l to 7l and 1r to 7r. The receiving locations 1l to 7l and 1r to 7r are numbered, each number corresponding to a specified tooth. 1l is the front incisor on the left, 1r is the front incisor on the right. The numbering goes up to 7l and 7r, corresponding to the buccal teeth furthest back on the left and right. The wisdom teeth are not taken into account in this example. It goes without saying that it would be possible also to provide a magazine 10 with 16 places.

Therefore, a magazine 10 according to FIG. 3 accommodates the teeth of a jaw. Each tooth is assigned a unique position in the magazine 10. If not all the teeth of a jaw are to be individually scanned, it must be ensured that the teeth are placed in the correct receiving location.

In addition to the numbering, the receiving locations 1l to 7l and 1r to 7r are also coded. This means that the models of single teeth can only be placed in the receiving locations 1l to 7l and 1r to 7r in a unique alignment. As a result, it is precisely known by the magazine 10 which tooth is in which alignment in which of the receiving locations 1l to 7l and 1r to 7r. The coding 11 is shown enlarged in a detail D in FIG. 3. In this example, the coding comprises that carrier elements 12 with coding pins 11, on which the model of a tooth can be uniquely placed, are provided in the receiving locations 1l to 7l and 1r to 7r. It is not possible to place the model of a tooth on the carrier elements 12 in any other alignment than that allowed by the coding defined by means of the coding pins 11.

The coding pins 11 correspond to the standard coding that is used by the dental technician when making the model. This standard coding can be seen from FIGS. 5a and 5b. The dental technician places the model of a set of teeth 20 on a respective base 27, the base 27 containing positioning pins 13. The model 20 can only be placed onto these positioning pins in one position. The same applies if the model 20 is sawn up into individual models of single teeth 22. Each model 32 can be placed onto the pins 12 in a unique way. The arrangement of the coding pins 11 (FIG. 3) corresponds to the arrangement of the positioning pins 13. A portion 14 of the base 27 is projected onto each carrier element 12 (FIG. 3) The carrier elements 12 (FIG. 3) are inserted together with the respective model of a single tooth 22 into the holder 4.2. Each carrier element 12 from FIG. 3 is coded with an electronic chip (not visible) for additional security, the electronic chip containing information on the number 1l to 7l or 1r to 7r of the receiving location and the alignment of the coding pins 11. Furthermore, a position marking 15 provides information on the alignment of the carrier 12. As a result, it is ensured that the models of single teeth 22 (FIG. 5a) are scanned in a unique position. The same procedure is used for coding the model 21 and the models of single teeth 23 of the lower jaw.

If the alignment of the individual models of single teeth 22, 23 is very exact, it is even possible to dispense with the scanning of the complete model of a set of teeth 20, 21. Great accuracy in the alignment is achieved for example by the coding pins 11 having a conical shape, as a result of which the mechanical play is reduced. The scanning of the complete model of a set of teeth 20, 21 can in principle be carried out less accurately than the scanning of an individual model of a single tooth 22, 23, because smaller objects can be recorded with greater accuracy. Furthermore, the scanning rate can be further increased if both holders 4.1 and 4.2 are fed by one magazine 10 with models of single teeth 22, 23.

In FIGS. 4a to 4e, models of sets of teeth are represented in various views. For scanning, the model of a set of teeth of a jaw 20 or 21 is clamped in the holder 4.1, while the other holder 4.2 is fed by the magazine 10. The removal of an object 1.2 from the magazine 10 and the insertion of the object 1.2 into the holder 4.2 is performed by a conventional robot arm ( n o t represented). The same robot arm takes the object 1.2 out of the holder 4.2 once measurement has been completed and inserts it again into the magazine 10. Therefore, one tooth 22, 23 after the other in the holder 4.2 is successively scanned.

It is possible to record the models of the upper jaw 20 and the lower jaw 21 in one scanning operation, by the two models 20 and 21 being fastened to each other back-to-back (see FIG. 4d). The scanning of the complete model of a set of teeth 20, 21 takes much longer than the scanning of an individual tooth 22, 23. Therefore, much time is saved by the simultaneous scanning of teeth, since the scanning of some teeth 22, 23 can be completed by the time the model of a set of teeth is scanned. A prerequisite for this is that, as represented in FIG. 1, the two holders 4.1 and 4.2 can be moved independently of each other.

Since the position and alignment of the individual teeth is known, all that remains is for the model of the set of teeth itself to be coded. As a result, the computational combination of the representations of the teeth and the representation of the set of teeth is made much easier. From the known data, the representation of a tooth can be inserted approximately correctly into the representation of the set of teeth. Just an error correction is necessary to allow the representation of the tooth to be inserted exactly into the representation of the set of teeth. The error correction is performed by methods known to a person skilled in the art; the method of least squares may be mentioned as an example.

For the alignment of the model of a set of teeth, it may be directly marked. It is particularly suitable if the models of an upper jaw 20 and a lower jaw 31 are fastened to each other back-to-back. This is preceded by a positioning of the models by the dental technician. In all three spatial dimensions, the models are oriented in the same way as in the jaw, which is carried out by the dental technician using the usual contrivances available to him. The aligned jaw models 20 and 21 match each other, as represented in FIG. 4a.

The models 20 and 21 aligned by the dental technician are subsequently marked. For the positioning in the x-y plane (biting plane), the models of the two jaws 20 and 21 are marked with an exactly coinciding equilateral triangle 24. It goes without saying that a shape other than a triangle 24 could also be used for the marking. The marking triangle 24 serves at the same time for identifying the alignment of the set of teeth. For example, the triangle on one of the two jaws 20 or 21, for example the upper jaw 20, may always be positioned in such a way that an extension of the base line b of the triangle passes through the space between the 6th tooth and the 7th tooth and an extension of the height h passes through the space between the two furthest forward incisors. If the marking is included in the scanning, it can be used as a basis for the referencing for the insertion of the representations of the models of single teeth.

It is also possible for the marking 24 only to be used to position the models of the upper jaw 20 and the lower jaw 31 exactly back-to-back. After the scanning, both models 20 and 21 must be computationally turned through 180°, then the alignment of the models in the x-y direction is correct. The back-to-back positioning is represented in FIG. 4d. The two jaw models 20 and 21 are kept in the mutually aligned position by means of the connection 28.

For fixing the distance between the two jaws 20 and 21, which corresponds to the alignment along the z axis, spacers 25 and 26 are fitted into the models of the upper jaw 20 and the lower jaw 31. Experience shows that wedge-shaped and groove-shaped spacers 25 and 26, which fit into one another, are particularly advantageous. This is represented in FIGS. 4b and 4c. The opening of the wedge 25 or the groove 26 may additionally contain the information concerning the direction in which the jaw is moved during a chewing motion.

Since the spacers are likewise included in the scanning, the representations of the upper jaw 20 and the lower jaw 21 are subsequently combined into a joint image. With suitable software, the chewing motion can be simulated. If dowel crowns, crowns or bridges are required, they can likewise be simulated with suitable software and made in accordance with the computation. The spacers 25 and 26 may additionally serve instead of the marking 24 for the referencing of the models.

FIGS. 6a and 6b show an object holder 4, which is suitable for receiving models of sets of teeth or single teeth 20 to 23. In particular if the models 20 and 21 of the upper jaw and lower jaw are to be scanned together, as represented in FIG. 4d, such a holder 4 is suitable, since it is robust enough to bear the weight of the complete model. The holder 4 preferably consists of aluminum, since it is lightweight. However, other resistant materials, such as for example steel or reinforced plastic, are also conceivable.

The holder 4 comprises three cylindrical portions 31, 32 and 33, which are located on a base plate 30. The cylindrical portion 31 is rotatable with respect to the base plate about the axis A31. When the portion 31 is turned, the upper two portions 32 and 33 are turned with it. The portion 32 is rotatable with respect to the portion 31 about the axis A32. The axis A32 precesses about the axis A31 when the portion 31 is turned about the axis A31. When there is rotation of the portion 32 about the axis A32, the cylindrical portion 31 is stationary, whereas the portion 33 is turned along with it. The cylindrical portion 33 is in turn rotatable about the axis A33 with respect to the portion 32. The axis A33 precesses about the axis A32 when the portion 32 is rotated about the axis A32. When there is rotation of the portion 33 about the axis A33, the lower two portions 31 and 32 are not turned along with it. Between the elements 30, 31, 32 and 33 there are ball bearings K31, K32 and K33, which facilitate the respective rotation. Various drives by which the cylindrical portions can be rotated are known to a person skilled in the art.

The axis A32 is tilted with respect to the axis A31 by an angle of about 8°. As a result, an object 1.1, which is fastened on the cylindrical portion 33, can be tilted with respect to the main axis of rotation by up to 16°. The alignment of the object 1.1 after the tilting is determined by a rotation of the portion 33 about the axis A33. With this holder 4, the object can therefore be rotated about the axis A31, various tilting positions of the object 1.1 being chosen. As a result, the object 1.1 can be scanned in various views. The effects of the tilting are described in detail in the application EP 04 00 5732.

1-18. (canceled)

19. A scanning arrangement for scanning objects with a focused light beam, the light beam being movable in relation to the surface of the object, wherein said arrangement comprises:
at least two object holders and means for producing at least one light beam for each object and light receivers respectively assigned to each light beam for the simultaneous scanning of at least two objects.

20. The scanning arrangement as claimed in claim 19, wherein two object holders are provided.

21. The scanning arrangement as claimed in claim 19, wherein at least one of the holders is assigned a magazine with receiving locations for receiving and providing a predetermined number of objects.

22. The scanning arrangement as claimed in claim 21, wherein the receiving locations of the magazine are numbered.

23. The scanning arrangement as claimed in claim 21, wherein the receiving locations of the magazine are coded for the unique reception of objects.

24. The scanning arrangement as claimed in claim 19, wherein the holders are designed for receiving models of sets of teeth and/or models of single teeth.

25. The scanning arrangement as claimed in claim 21, wherein the receiving locations of the magazine are designed for the ordered and/or coded reception of models of single teeth.

26. The scanning arrangement as claimed in claim 19, further comprising a mirror arrangement, by means of which the light beams from at least two light sources are directed onto the corresponding object.

27. The scanning arrangement as claimed in claim 19, wherein at least two holders are movably arranged.

28. The scanning arrangement as claimed in claim 27, further comprising a common drive for moving at least two holders.

29. A method for scanning objects with a focused light beam, in particular in an arrangement as claimed in claim 19, said method comprising a step of scanning at least two objects at the same time by the same scanning arrangement, at least one light beam being used for the scanning of each object.

30. The method as claimed in claim 29, wherein two objects are scanned at the same time.

31. The method as claimed in claim 29, wherein said objects are models of sets of teeth and/or models of single teeth.

32. The method as claimed in claim 29, further comprising combining digital representations of the simultaneously scanned objects into one image.

33. The method as claimed in claim 29, wherein an object and a detail of the same, preferably a model of a set of teeth and one or more models of single teeth from the latter, are scanned simultaneously.

34. The method as claimed in claim 33, further comprising combining the digital representations of the object and of the detail to form an at least partially overlapping representation.

35. The method as claimed in claim 33, wherein the alignment of the object and of the detail with respect to each other is referenced.

36. The method as claimed in one of claim 29, wherein light beams from at least two light sources are directed to the object by means of a common mirror arrangement.
